(19) United States
(12) Patent Application Publication
(10) Pub. No.: US 2014/0298186 A1
(43) Pub. Date: Oct. 2, 2014

(54) ADJUSTING INFORMATION PROMPTING IN INPUT METHOD

(71) Applicant: International Business Machines Corporation, Armonk, NY (US)

(72) Inventors: Sheng Hua Bao, Beijing (CN); Jian Chen, Beijing (CN); Yong Qin, Beijing (CN); Qin Shi, Beijing (CN); Zhong Su, Beijing (CN); Liu Wen, Beijing (CN); Shi Lei Zhang, Beijing (CN)

(73) Assignee: International Business Machines Corporation, Armonk, NY (US)

(21) Appl. No.: 14/225,524

(22) Filed: Mar. 26, 2014

(30) Foreign Application Priority Data
Mar. 29, 2013 (CN) 201310106283.3

(51) Int. Cl. G06F 3/0482

(52) U.S. Cl. CPC G06F 3/0482
USPC 715/738

(57) ABSTRACT

A computer-implemented method and apparatus for adjusting information prompting in an input method. The method includes: obtaining prompt information displayed in response to entering a word in an input box by a user; and adjusting the sequence of subsequent prompt words in a prompt box of the input method according to the prompt information. The method for adjusting information prompting in an input method according to the embodiments of the present invention can adjust the sequence of prompt words in the prompt box of the input method in real time based on prompt information in the prompt box to facilitate user selection.

### CROSS-REFERENCE TO RELATED APPLICATION

This application claims priority under 35 U.S.C. §119 from Chinese Patent Application No. 201310106283.3 filed Mar. 29, 2013, the entire contents of which are incorporated herein by reference.

### BACKGROUND OF THE INVENTION

The present invention relates to information prompting in an input method. More specifically, the present invention relates to a method and apparatus for adjusting information prompting in an input method.

Recently, with the participation of so many competitors, competition for internet portals between various internet enterprises has become increasingly fierce. As a result input methods, as an important and fundamental application of internet portals, have become a main battlefield of internet giants. With the fusion of Internet and mobile networks, especially with the push of 3G networks, mobile internet applications are becoming increasingly abundant. Mobile phone operating systems, mobile phone browsers, mobile phone input methods, and mobile phone search engines are all “portals” faced directly by users. More and more customers thirst for sufficient network experiences on their mobile devices. Consequently, mobile phone input methods are undoubtedly one of the most important foundations of those portals and their inventiveness and practicability can influence the ordinary experience of every user.

In existing input methods, words in a word stock are sorted according to a predetermined sorting rule and those sorted words are pushed to users. However, the sorting rule cannot be adjusted dynamically. Information on the Internet varies all the time and a word stock with a constant sorting sequence cannot reflect such variations. Therefore, information prompted to the user cannot reflect such variations either. Currently, in many applications provided with an input box (such as search engines and electrical forms) when a user enters a word in the input box, it is not unusual for the user to switch several times on a prompt box of the input method until a required word is found. Although existing input methods can update their word stocks periodically according to the variations on the Internet and can adjust their sorting sequences, such updating cannot keep up with real-time variations on the Internet. Techniques in the prior art cannot achieve real-time prompt information adjustment for input methods according to particular situations.

Therefore, a new method for adjusting information prompting in an input method is desired, which can technically adjust the sequence of prompt words in the prompt box of the input method in real time to facilitate user's choice.

### SUMMARY OF THE INVENTION

According to one embodiment of the present invention, there is provided a method for adjusting information prompting in an input method, including: obtaining prompt information displayed in response to entering a word in an input box by a user; and adjusting the sequence of subsequent prompt words in a prompt box of the input method according to the prompt information.

According to another embodiment of the present invention, there is provided an apparatus for adjusting information prompting in an input method, including: a prompt information obtaining module, configured to obtain prompt information displayed in response to entering a word in an input box by a user; and a first adjustment module, configured to adjust the sequence of subsequent prompt words in a prompt box of the input method according to the prompt information.

According to another embodiment of the present invention, there is provided a non-transitory computer readable storage medium tangibly embodying a computer readable program code having computer readable instructions which, when implemented, cause a computer device to carry out the steps of a method for adjusting information prompting in an input method. The method includes the steps of: obtaining a prompt information displayed in response to entering a word in an input box by a user; and adjusting sequence of a plurality of subsequent prompt words in a prompt box of the input method according to the prompt information.

Using the prompt information in the input box, the method and apparatus for adjusting information prompting in an input method according to the embodiments of the present invention can adjust the sequence of prompt words in the prompt box of the input method in real time by utilizing prompt information in the input box, greatly facilitating user selection.

### BRIEF DESCRIPTION OF THE DRAWINGS

Through the more detailed description of some embodiments of the present invention in the accompanying drawings, the above and other objects, features and advantages of the present invention are made more apparent. The same reference generally refers to the same components in the embodiments of the present invention.

FIG. 1 shows an exemplary computer system which is applicable to implement an embodiment of the present invention.

FIG. 2 shows a method for adjusting information prompting in an input method according to an embodiment of the present invention.

FIG. 3 shows an embodiment of the method for adjusting information prompting in an input method according to an embodiment of the present invention.

FIG. 4 shows the default sequence of the prompt box of the input method according to an embodiment of the present invention.

FIG. 5 shows the adjusted sequence of the prompt box of the input method according to an embodiment of the present invention.

FIG. 6 shows an example according to an embodiment of the present invention, in which input box prompt information is blocked by the prompt box of the input method.

FIG. 7 shows an example of the occlusion of the prompt box of the input method according to an embodiment of the present invention.

FIG. 8 shows an example of the occlusion of the prompt box of the input method which is located according to an embodiment of this invention;

FIG. 9 shows an apparatus for adjusting information prompting in an input method according to an embodiment of the present invention.

### DETAILED DESCRIPTION OF THE PREFERRED EMBODIMENT

Some preferable embodiments are described in more detail with reference to the accompanying drawings, in which the preferable embodiments of the present invention have been illustrated. However, the present invention can be implemented in various manners and, thus, is not construed to be limited to the embodiments disclosed herein. On the contrary, those embodiments are provided for the thorough and complete understanding of the present invention and for completely conveying the scope of the present invention to those skilled in the art.

As will be appreciated by one skilled in the art, aspects of the present invention can be embodied as a system, method, or computer program product. Accordingly, aspects of the present invention can take the form of an entirely hardware embodiment, an entirely software embodiment (including firmware, resident software, micro-code, etc.), or an embodiment combining software and hardware aspects that can all generally be referred to herein as a “circuit,” “module,” or “system.” Furthermore, aspects of the present invention can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium including, but not limited to, wireless, wireline, optical fiber cable, RF, etc., or any suitable combination of the foregoing.

Computer program code for carrying out operations for aspects of the present invention can be written in any combination of one or more programming languages, including an object oriented programming language such as Java, Smalltalk, C++, or similar programming languages and conventional procedural programming languages, such as the “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatus (systems), and computer program products according to embodiments of the present invention. Understand that each block of the flowchart illustrations and/or block diagrams and combinations of blocks in the flowchart illustrations and/or block diagrams can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flowchart and/or block diagram block or blocks.

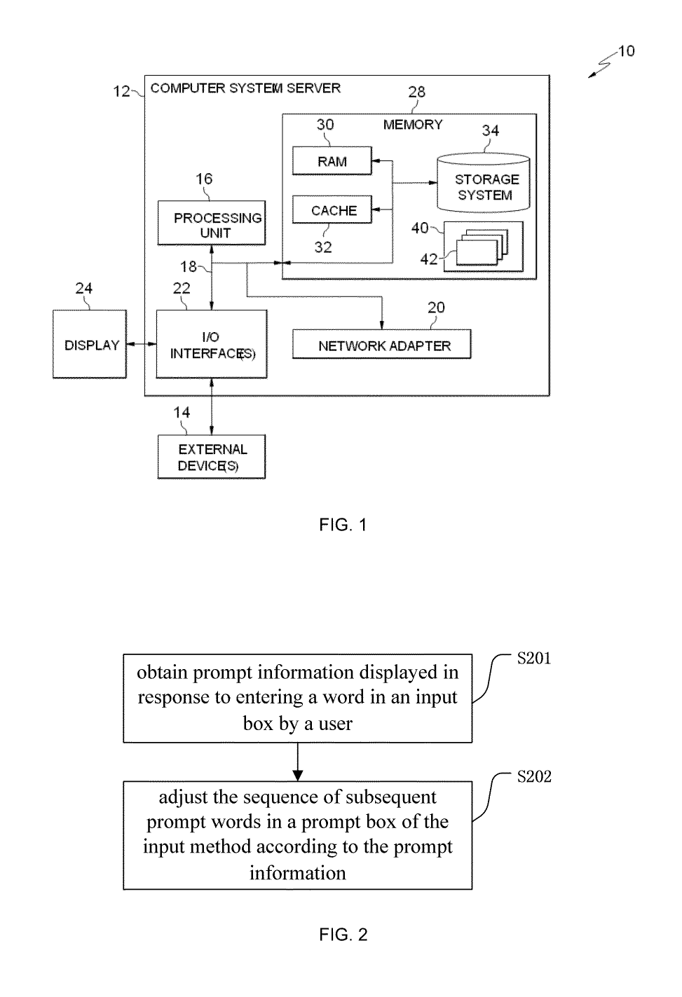

Refer now to FIG. 1, in which an exemplary computer system/server 12 which is applicable to implement embodiments of the present invention is shown. Computer system/server 12 is only illustrative and is not intended to suggest any limitation as to the scope of use or functionality of embodiments of the present invention described herein.

As shown in FIG. 1, computer system/server 12 is shown in the form of a general-purpose computing device. The components of computer system/server 12 can include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM or other optical media can be provided. In such instances, each can be connected to bus 18 by one or more data media interfaces. As is further depicted and described below, memory 28 can include at least one program product having a set (e.g., at least one) of program modules that are configured to carry out the functions of embodiments of the present invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the present invention as described herein.

Computer system/server 12 can also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. Understand that, although not shown, other hardware and/or software components can be used in conjunction with computer system/server 12. Examples, include, but are not limited to: microcode, device drivers, redundant processing units, external disk drive arrays, RAID systems, tape drives, and data archival storage systems, etc.

FIG. 2 shows a method for adjusting information prompting in an input method according to an embodiment of the present invention, which includes: at step S201, obtaining prompt information displayed in response to entering a word in an input box by a user; and at step S202, adjusting the sequence of subsequent prompt words in a prompt box of the input method according to the prompt information.

At step S201, prompt information displayed in response to entering a word in an input box by a user is obtained. As to an application having an input box with prompt information (such as a search engine, an electrical form, etc.), when a user enters input content in the input box, prompt information is popped out near the input box, wherein the prompt information generally includes the hottest and most appropriate key words that are mined from the Internet.

According to an embodiment of the present invention, after the prompt information of the input box is displayed on a user interface, displayed information can be obtained from the user interface. According to another embodiment of the present invention, for a network application, a request for entering a word by the user in the input box is redirected to a network server, a response from the network server is received, and the content of the displayed information is obtained from the returned response.

At step S202, the sequence of subsequent prompt words in a prompt box of the input method is adjusted according to the prompt information. According to the method of the present invention, the sequence of input prompt words is adjusted in real time by using the content of the input box prompt information. Particularly: in response to entering an input code of a next word by the user, a set of candidate words corresponding to the input code is obtained in the prompt box of the input method; words contained in the set of candidate words are identified from the prompt information; and according to the property of the identified word, the sequence of subsequent prompt words in the prompt box of the input method is adjusted. The property includes at least one of: the occurrence frequency of the word in the prompt information, the position of the word in the prompt information, and the word length.

Those skilled in the art can understand that the input code herein can be any input code in the prior art, for example a Pinyin code, an English code, a Wubi code, or a Zhengma code.

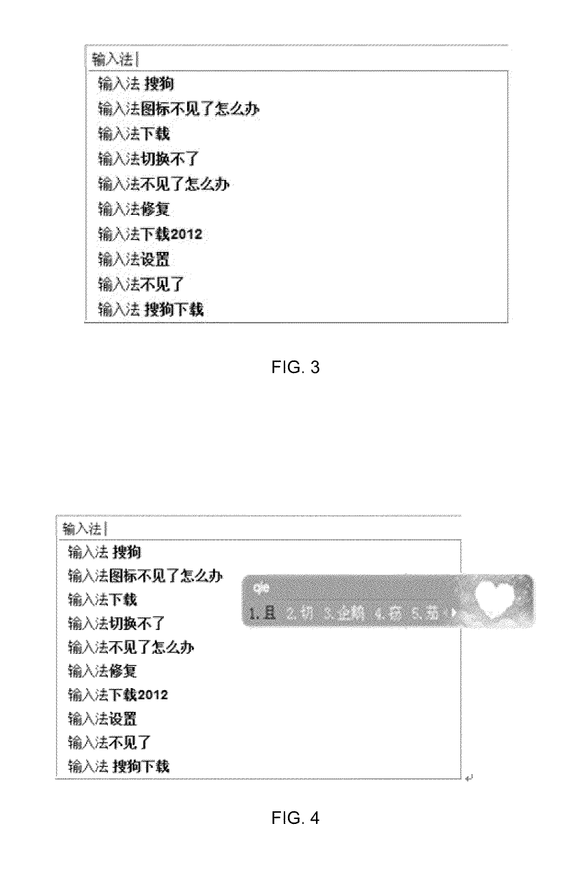

FIG. 3 shows a method for adjusting information prompting in an input method according to an embodiment of the present invention. “ [symbol] ” are inputted in an input box and prompt information is popped out under the input box. First of all, word segmentation is carried out for the prompt contents of the prompt information. Firstly, it is required to perform Chinese word segmentation on the prompt information. Chinese word segmentation refers to segmenting a sequence of Chinese words into individual tokens. Existing word segmentation algorithms can be divided into three classes: string matching based word segmentation methods, understanding based word segmentation methods, and statistics based word segmentation methods. An introduction to the above three classes of word segmentation algorithms can be found in Baidu Baike (http://baike.baidu.com/view/19109.htm), which will not be described in detail herein. Currently existing and other technical means that can emerge in the future for word segmentation are all within the scope of the present invention. According to the method introduced above, the word segmentation result is as follows:

[symbol]

[symbol]

[symbol]

[symbol]

[symbol]

[symbol]

[symbol]

[symbol] 2012

[symbol]

[symbol]

[symbol]

[symbol]

[symbol] .

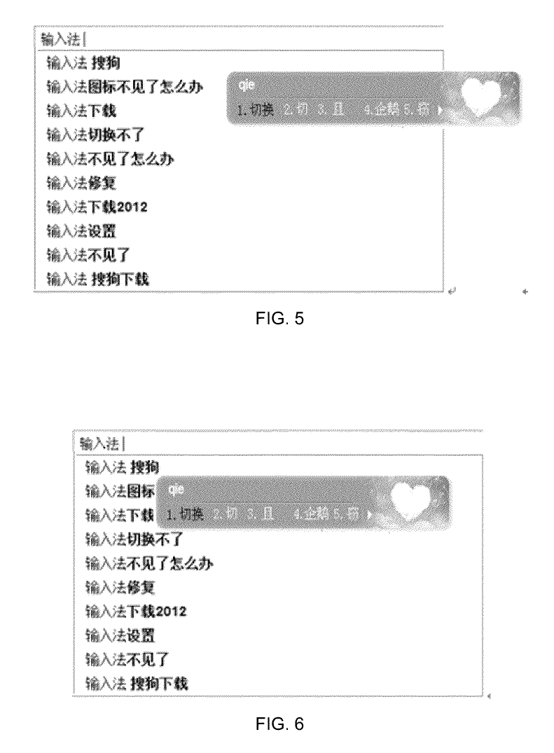

In this embodiment, a pinyin string “qie” is inputted after “ [symbol] ” and a set of candidate words corresponding to the pinyin string “qie” is obtained from the word stock of the input method: [symbol] , [symbol] , [symbol] , [symbol] , [symbol] , [symbol] , [symbol] . Each word of the input method has a default weighted score, through sorting by their weighted scores, for example [symbol] (70), [symbol] (68), [symbol] (65), [symbol] (64), [symbol] (60), [symbol] (58), [symbol] (55), the sequence of those words in the prompt box of the input method is shown as FIG. 4. Herein, it is defined that once a word in the candidate word set appears in a prompt line, its weighted score is increased by W=20*(1-0.2*word distance)*(word length/the length of a token containing that word in the prompt information) on the base of its default weighted score. At first, words “ [symbol] ” and “ [symbol] ” in the set of candidate words are identified in the prompt lines of the prompt information. Then, weighted scores of “ [symbol] ” and “ [symbol] ” are calculated. In “ [symbol] ”, the distance between the position of “ [symbol] ” and the position of “ [symbol] ” is 0, the length of “ [symbol] ” is 1, and the length of the token “ [symbol] ” containing “ [symbol] ” is 2, the weighted score of “ [symbol] ” should be increased by 20*(1-0.2*0)*(1/2)=10. At the same time, “ [symbol] ” also appears in “ [symbol] ”, so that the score can be further increased by 20*(1-0.2*1)*(1/2)=8. Finally, the weighted score of “ [symbol] ” is 68+10+8=86. In “ [symbol] ”, the distance between the position of “ [symbol] ” and the position of “ [symbol] ” is 0, the length of “ [symbol] ” is 2, the length of the token containing “ [symbol] ” is 2, the weighted score of “ [symbol] ” should be increased by 20*(1-0.2*0)*(2/2)=20. At the same time, “ [symbol] ” also appears in “ [symbol] ” and the weighted score of “ [symbol] ” should be further increased by 20*(1-0.2*1)*(2/2)=16. Finally, the weighted score of “ [symbol] ” is 55+20+16=91. Words in the prompt box of the input method are re-sorted according to the new weighted scores, and the result of the sorting is: [symbol] (91), [symbol] (86), [symbol] (70), [symbol] (65), [symbol] (64), [symbol] (60), [symbol] (58), so that the re-sorted sequence in the prompt box of the input method is shown as FIG. 5.

The initial popup position of the prompt box of the input method in existing input methods generally depends on the position of the cursor. However, it has been found in existing applications that the prompt information of the input box is usually blocked by the popup prompt box of the input method, in which case it is necessary for the user to adjust the position of the prompt box of the input method manually. However, the prompt box of the input method has a constant position on mobile devices and thus the user can do nothing when occlusion occurs.

According to an embodiment of the present invention, the method further includes: adjusting the display position of the prompt box of the input method to prevent the prompt information from being blocked by the prompt box of the input method. The method can be used to adjust the position of the prompt box of the input method on non-mobile devices, such as desktop computers.

Particularly, according to an embodiment of the present invention, the method includes: calculating the horizontal coordination of the last word in the longest prompt line of the prompt information; and arranging the left edge of the prompt box of the input method at a position having a horizontal coordination larger than that of the last word in the last prompt line.

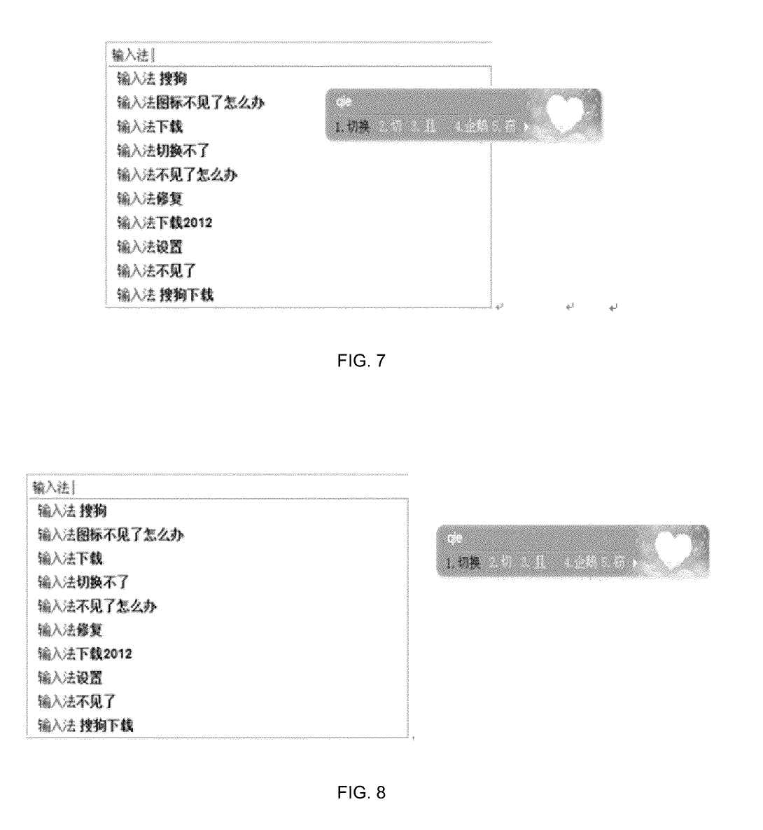

FIG. 6 shows an example according to an embodiment of the present invention, in which input box prompt information is blocked by the prompt box of the input method. According to the method of an embodiment of the present invention, the content of a prompt column is obtained, which includes ten prompt lines, wherein the second line is the longest, having 11 words in total. The horizontal coordination of the left edge of the input box is 310, wherein the horizontal coordination is in the unit of one pixel. Assume that each word occupies about 11 pixels and the horizontal coordination of the 11^{th} word is 421. Thus, the left edge of the prompt box of the input method is arranged at a position having a horizontal coordination larger than 421, as shown in FIG. 7, so that the content of the prompt information cannot be blocked.

According to another embodiment of the present invention, the method includes: obtaining the horizontal coordination of the right edge of the prompt information column; and arranging the left edge of the prompt box of the input method at a position having a horizontal coordination larger than the horizontal coordination of the right edge of the prompt information column.

As to the example of FIG. 6, the obtained horizontal coordination of the right edge of the prompt information column is 800, in the unit of one pixel. Then, the left edge of the prompt box of the input method is arranged at a position having a horizontal coordination larger than 800, as shown in FIG. 8, so that the content of the prompt information cannot be blocked.

According to an embodiment of the present invention, the method further includes: adjusting the position of the input box on the user interface to prevent the prompt information from being blocked by the prompt box of the input method. This method can be used for mobile devices such as mobile phones. Since in the applications of mobile devices (such as mobile phones) the position of the prompt box of the input method is unchanged, it is possible to prevent the prompt information from being blocked by the prompt box of the input method through adjusting the position of the user interface. Particularly, the user interface on which the input box locates can be arranged above the upper boundary of the prompt box of the input method.

According to an embodiment of the present invention, the method further includes: in response to determining that a word contained in the prompt information is not included in the word stock of the input method, expanding the word stock of the input method with the word contained in the prompt information which is not included in the word stock so that the words in the word stock are updated with hot words on the Internet timely.

An embodiment of the present invention is illustrated with an example of a Chinese input method merely for the purpose of description, but it is not intended to limit the input method and apparatus of the present invention. Those skilled in the art can understand that the input method and apparatus of an embodiment of the present invention can be applied to any input method provided with a prompt box, including foreign language input methods with candidate information.

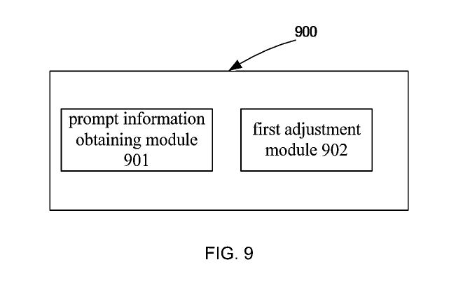

An apparatus for adjusting information prompting in an input method is further provided in the present invention. FIG. 9 shows an apparatus 900 for adjusting information prompting in an input method according to an embodiment of the present invention, including: a prompt information obtaining module 901, configured to obtain prompt information displayed in response to entering a word in an input box by a user; and a first adjustment module 902, configured to adjust the sequence of subsequent prompt words in a prompt box of the input method according to the prompt information.

According to an embodiment of the present invention, wherein the first adjustment module 902 includes: a word set obtaining module configured to, in response to inputting an input code of a next word by the user, obtain a set of candidate words corresponding to the input code; an identification module configured to identify words contained in the set of candidate words from the prompt information; and a second adjustment module configured to adjust the sequence of subsequent prompt words in the prompt box of the input method according to the properties of the identified words.

According to an embodiment of the present invention, wherein the sequence of subsequent prompt words in the prompt box of the input method is adjusted according to at least one of the following properties of the identified words: the occurrence frequency of a word in the prompt information, the position of a word in the prompt information, and the length of a word.

According to an embodiment of the present invention, the apparatus further includes: a position adjustment module configured to adjust the position of the prompt box of the input method on the user interface to prevent the prompt information from being blocked by the prompt box of the input method.

According to an embodiment of the present invention, wherein the position adjustment module further includes: a horizontal coordination calculation module configured to calculate the horizontal coordination of the last word in the longest prompt line of the prompt information; and a first location module configured to arrange the left edge of the prompt box of the input method at a position having a horizontal coordination larger than the horizontal coordination of the last word in the longest prompt line.

According to an embodiment of the present invention, wherein the position adjustment module further includes: a horizontal coordination obtaining module configured to obtain the horizontal coordination of the right edge of the prompt information column; and a second location module configured to arrange the left edge of the prompt box of the input method at a position having a horizontal coordination larger than the horizontal coordination of the right edge of the prompt information column.

According to an embodiment of the present invention, the apparatus further includes: a user interface adjustment module configured to adjust the position of a user interface on which the input box locates to prevent the prompt information from being blocked by the prompt box of the input method.

According to an embodiment of the present invention, wherein the user interface adjustment module is configured to arrange the user interface on which the input box locates above the upper boundary of the prompt box of the input method.

According to an embodiment of the present invention, the apparatus further includes a word stock expansion module configured to, in response to determining that a word in the prompt information is not included in the word stock of the input method, add the word in the prompt information that is not included in the word stock of the input method to the word stock of the input method.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which includes one or more executable instructions for implementing the specified logical function(s). Note that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. Note that each block of the block diagrams and/or flowchart illustration and combinations of blocks in the block diagrams and/or flowchart illustration can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for adjusting information prompting in an input method, wherein the computer includes a processor communicatively coupled to a memory, the method comprising the steps of:
obtaining a prompt information displayed in response to entering a word in an input box by a user; and
adjusting sequence of a plurality of subsequent prompt words in a prompt box of the input method according to the prompt information.

2. The computer-implemented method according to claim 1, wherein the step of adjusting sequence of the plurality of subsequent prompt words in the prompt box of the input method according to the prompt information comprises:
in response to inputting an input code of a next word by the user, obtaining a set of candidate words corresponding to the input code from a word stock of the input method;
identifying a plurality of words contained in the set of candidate words from the prompt information; and
adjusting the sequence of the plurality of subsequent prompt words in the prompt box of the input method according to an at least one property of a plurality of identified words.

3. The computer-implemented method according to claim 2, wherein the sequence of the plurality of subsequent prompt words in the prompt box of the input method is adjusted according to at least one of the following properties of the plurality of identified words: an occurrence frequency of a word in the prompt information, a position of a word in the prompt information, and a word length.

4. The computer-implemented method according to claim 1, further comprising:
adjusting a position of the prompt box of the input method on the user interface to prevent the prompt information from being blocked by the prompt box of the input method.

5. The computer-implemented method according to claim 4, further comprising:
calculating a horizontal coordination of a last word in a longest prompt line of the prompt information; and
arranging a left edge of the prompt box of the input method at a position having a horizontal coordination larger than the horizontal coordination of the last word in the longest prompt line.

6. The computer-implemented method according to claim 4, further comprising:
obtaining the horizontal coordination of a right edge of the prompt information column; and
arranging the left edge of the prompt box of the input method at a position having a horizontal coordination larger than the horizontal coordination of the right edge of the prompt information column.

7. The computer-implemented method according to claim 1, further comprising:
adjusting the position of a user interface on which the input box locates to prevent the prompt information from being blocked by the prompt box of the input method.

8. The computer-implemented method according to claim 7, wherein the step of adjusting the position of the user interface on which the input box locates comprises:
arranging the user interface on which the input box locates above an upper boundary of the prompt box of the input method.

9. The computer-implemented method according to claim 1, further comprising:
in response to determining that a word in the prompt information is not comprised in the word stock of the input method, adding the word in the prompt information that is not comprised in the word stock of the input method to the word stock of the input method.

10. An apparatus for adjusting information prompting in an input method, the apparatus comprising:
a memory;
a processor communicatively coupled to the memory; and
a module for adjusting information prompting in the input method, wherein the module is configured to perform the steps of a method comprising:
obtaining a prompt information displayed in response to entering a word in an input box by a user; and
adjusting sequence of a plurality of subsequent prompt words in a prompt box of the input method according to the prompt information.

11. The apparatus according to claim 10, wherein the step of adjusting sequence of the plurality of subsequent prompt words in the prompt box of the input method according to the prompt information comprises:
in response to inputting an input code of a next word by the user, obtaining a set of candidate words corresponding to the input code from a word stock of the input method;
identifying a plurality of words contained in the set of candidate words from the prompt information; and
adjusting the sequence of the plurality of subsequent prompt words in the prompt box of the input method according to an at least one property of a plurality of identified words.

12. The apparatus according to claim 11, wherein the sequence of the plurality of subsequent prompt words in the prompt box of the input method is adjusted according to at least one of the following properties of the plurality of identified words: an occurrence frequency of a word in the prompt information, a position of a word in the prompt information, and a word length.

13. The apparatus according to claim 10, wherein the method further comprises:
adjusting a position of the prompt box of the input method on the user interface to prevent the prompt information from being blocked by the prompt box of the input method.

14. The apparatus according to claim 13, wherein the method further comprises:
calculating a horizontal coordination of a last word in a longest prompt line of the prompt information; and
arranging a left edge of the prompt box of the input method at a position having a horizontal coordination larger than the horizontal coordination of the last word in the longest prompt line.

15. The apparatus according to claim 13, wherein the method further comprises:
obtaining the horizontal coordination of a right edge of the prompt information column; and
arranging the left edge of the prompt box of the input method at a position having a horizontal coordination larger than the horizontal coordination of the right edge of the prompt information column.

16. The apparatus according to claim 10, wherein the method further comprises:
adjusting the position of a user interface on which the input box locates to prevent the prompt information from being blocked by the prompt box of the input method.

17. The apparatus according to claim 16, wherein the step of adjusting the position of the user interface on which the input box locates comprises:
arranging the user interface on which the input box locates above an upper boundary of the prompt box of the input method.

18. The apparatus according to claim 10, wherein the method further comprises:
in response to determining that a word in the prompt information is not comprised in the word stock of the input method, adding the word in the prompt information that is not comprised in the word stock of the input method to the word stock of the input method.

19. A non-transitory computer readable storage medium tangibly embodying a computer readable program code having computer readable instructions which, when implemented, cause a computer device to carry out the steps of a method for adjusting information prompting in an input method, the method comprising:
obtaining a prompt information displayed in response to entering a word in an input box by a user; and
adjusting sequence of a plurality of subsequent prompt words in a prompt box of the input method according to the prompt information.

20. The computer readable storage medium according to claim 19, wherein the step of adjusting sequence of the plurality of subsequent prompt words in the prompt box of the input method according to the prompt information comprises:
in response to inputting an input code of a next word by the user, obtaining a set of candidate words corresponding to the input code from a word stock of the input method;
identifying a plurality of words contained in the set of candidate words from the prompt information; and
adjusting the sequence of the plurality of subsequent prompt words in the prompt box of the input method according to an at least one property of a plurality of identified words.
